(19) United States
(12) Patent Application Publication
(10) Pub. No.: US 2017/0255162 A1
(43) Pub. Date: Sep. 7, 2017

(54) FIXING DEVICE AND IMAGE FORMING APPARATUS

(71) Applicant: FUJI XEROX CO., LTD., Tokyo (JP)

(72) Inventors: Yohei TAZAKI, Ebina-shi (JP); Tetsuya FURUYAMA, Yokohama-shi (JP)

(73) Assignee: FUJI XEROX CO., LTD., Tokyo (JP)

(21) Appl. No.: 15/250,561

(22) Filed: Aug. 29, 2016

(30) Foreign Application Priority Data
Mar. 2, 2016 (JP) 2016-040491

(51) Int. Cl. G03G 15/20

(52) U.S. Cl. CPC G03G 21/206; G03G 15/2053

(57) ABSTRACT

Provided is a fixing device that has a pair of fixing members that contacts each other at a contact region, rotates in a direction opposite to each other or circularly moves in a direction opposite to each other, transports a sheet which holds a toner image, and fixes the toner age on the sheet by heating and pressing the sheet during passing through the contact region; and a blocking member that blocks an air flow along at least one of the pair of the fixing member, the air flow flowing from a sheet outlet port side of the contact region to a sheet inlet side of the contact region, and the air flow being generated due to the rotation or the circular movement of the pair of the fixing members.

### CROSS-REFERENCE TO RELATED APPLICATIONS

This application is based on and claims priority under 35 USC 119 from Japanese Patent Application No. 2016-040491 filed Mar. 2, 2016.

### BACKGROUND

(i) Technical Field

The present invention relates to a fixing device and an image forming apparatus.

(ii) Related Art

In a duplex printing mode in which images are formed on both surfaces of a sheet, there is a problem that a disturbed image is formed on a second surface of the sheet.

### SUMMARY

According to an aspect of the invention, there is provided a fixing device that has a pair of fixing members that contacts each other at a contact region, rotates in a direction opposite to each other or circularly moves in a direction opposite to each other, transports a sheet which holds a toner image, and fixes the toner image on the sheet by heating and pressing sheet during passing through the contact region; and a blocking member that blocks an air flow along at least one of the pair of the fixing member, the air flow flowing from a sheet outlet port side of the contact region to a sheet inlet side of the contact region, and the air flow being generated due to the rotation or the circular movement of the pair of the fixing members.

### BRIEF DESCRIPTION OF THE DRAWINGS

Exemplary embodiments of the present invention will be described in detail based on the following figures, herein:

FIG. 1 is a view illustrating a configuration of a main portion of an image forming apparatus as an exemplary embodiment of the invention; and

FIG. 2 is an enlarged view of a fixing machine configuring the image forming apparatus illustrated in FIG. 1.

### DETAILED DESCRIPTION

Hereinafter, an exemplary embodiment of the invention will be described.

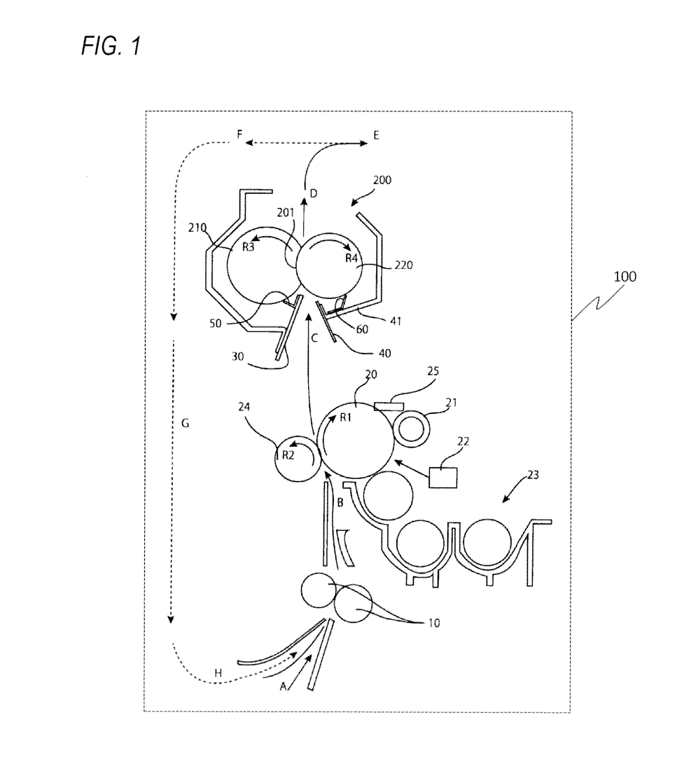

FIG. 1 is a view illustrating a configuration of a main portion of an image forming apparatus as an exemplary embodiment of the invention. An image forming apparatus 100 illustrated in FIG. 1 includes a fixing machine 200 as an exemplary embodiment of the fixing device of the invention.

A sheet fed from a sheet tray (not illustrated) advances in a direction of arrow A, and a leading end thereof arrives at standby rolls 10. Thereafter, a transport timing is adjusted and the sheet is further fed in a direction of arrow B. The sheet fed in the direction of the arrow B passes through between a photoconductor drum 20 rotating in a direction of arrow R1 and a transfer roll 24 rotating in a direction of arrow R2, and is further transported in a direction of arrow C. Then, the sheet is transported in a direction of arrow D by being sandwiched between a pressure roll 210 rotating in a direction of arrow R3 and a heating roll 220 rotating in a direction of arrow R4, which configure the fixing machine 200, while being guided by guide members 30 and 40. Furthermore, the sheet is discharged on an ejection (not illustrated) in a direction of arrow E.

In a duplex printing mode in which images are formed on both surfaces of the sheet, first, an image is formed on a first surface of the sheet while following the same transporting path as in the above description. Then, the sheet, where the image is formed on the first surface, is reversed in the sheet transport direction in the course of being discharged on the ejection tray in the direction of the arrow E. Now, the sheet is transported along arrows F, G, and H, and arrives again at the standby roll 10. In this case, the sheet is in a posture in which a front surface and a back surface are reversed, and the leading end and a trailing end of the sheet in the transporting direction are reversed from those during the formation of the image on the first surface. Thereafter, the sheet that arrives again at the standby roll 10 follows the same transporting path as that during the formation of the image on the first surface during which an image is formed on the second surface of the sheet. Now, the sheet is discharged on the ejection tray in the direction of the arrow E.

Here, a charging unit 21, an exposure device 22, and a developing device 23 are disposed around the photoconductor drum 20.

A toner image is formed on the photoconductor drum 20 by processing of charging, exposing, and developing by the charging unit 21, the exposure device 22, and the developing device 23. The toner image formed on the photoconductor drum 20 is transferred on the sheet, which is fed and transported from the standby roll 10, by an operation of a transfer bias applied to the transfer roll 24.

The sheet in which the transfer of the goner image is received is transported to the fixing machine 200 in the direction of the arrow C. On the other hand, toner remaining on the photoconductor drum 20 after the transfer is removed from the photoconductor drum 20 by a cleaner 25.

The fixing machine 200 includes the pressure roll 210 and the heating 20. The pressure roll 210 and the heating roll 220 are rotated in directions opposite to each other (the pressure roll 210 is rotated in the direction of the arrow R3 and the heating roll 220 is rotated in the direction of the arrow R4) while forming a contact region 201 by being in contact with each other. The pressure roll 210 and the heating roll 220 correspond to an example of a pair of fixing members referred in the exemplary embodiment of the invention.

The fixing machine 200 presses and heats the sheet by the pressure roll 210 and the heating roll 220 while the sheet passes through the contact region 201 and thereby the toner image on the sheet is fixed to the sheet.

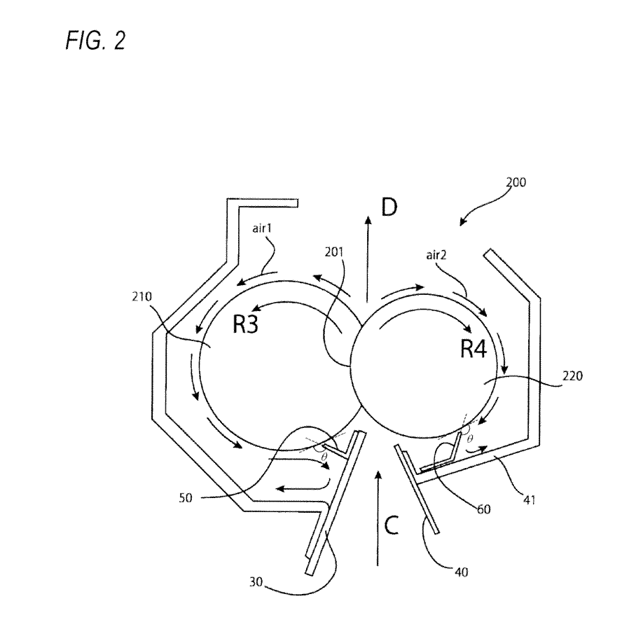

FIG. 2 is an enlarged view of the fixing machine configuring the image forming apparatus illustrated in FIG. 1.

The pressure roll 210 and the heating roll 220 configuring the fixing machine 200 are rotated respectively n the directions of the arrows R3 and R4. Therefore, air flows air1 and air2, which flow from an outlet port side (upper side of the contact region 201) of the sheet from the contact region 201 to an inlet side (lower side of the contact region 201) of the sheet to the contact region 201 along the pressure roll 210 and the heating roll 220, are generated. Moisture evaporated from the sheet, which is pressed and heated by the fixing machine 200, is contained in the air flows air1 and air2. Particularly, a large amount of moisture is contained in the sheet under a high-temperature and high-humidity environment, a large amount of moisture is evaporated from the sheet in the fixing machine 200, and the air flows air1 and air2 containing a large amount of moisture are generated.

Here, blocking members 50 and 60 are disposed on both sides of the pressure roll 210 side and the heating roll 220 side in the fixing machine 200. One blocking member 50 among the both blocking members 50 and 60 is supported on a guide member 30 and the other blocking member 60 is supported on a support member 41 which supports a guide member 40. The blocking members 50 and 60 block flowing of the air flows air1 and air2 on the inlet side (lower side of the contact region 201) of the sheet to the contact region 201 along the pressure roll 210 and the heating roll 220. Further, an angle θ between a tip direction in which a tip of each blocking member extends and a tangential line direction of each fixing member where the tip direction crosses the surface of the fixing member may be an obtuse angle. A distance between each blocking member and each fixing member may be preferably set to 2 mm or less.

A case where the blocking members 50 and 60 are not provided will be described. If the blocking members 50 and 60 are not provided, the air flows air1 and air2 containing a large amount of moisture abut against a portion of the sheet on the inlet side to the contact region 201 of the sheet, moisture in the air flows air1 and air2 is sucked into the sheet, and particularly the trailing end portion of the sheet is in a state where a water content is very high. In this state, the image formation is performed on the second surface of the duplex printing mode. The trailing end (that is, the leading end of the sheet during the image formation on the second surface) of the sheet during the image formation on the first surface, which is in a state where the water content is very high by causing the air flows air1 and air2 to abut against the sheet during the image formation on the first surface, is transported toward the image formation on the second surface in a state of being sandwiched between the photoconductor drum 20 and the transfer roll 24. Then, an electrical potential or the transfer bias of the toner image of the surface of the photoconductor drum 20 is disturbed and an image, in which powder of a powder toner image is rubbed as it is, is formed in the leading end portion of the sheet during the image formation on the second surface due to rich moisture contained in the sheet.

The blocking members 50 and 60 are members for avoiding direct contact of the air flows air1 and air2 with the sheet. In the exemplary embodiment, it is possible to suppress disturbance of the image during the image formation on the second surface in the duplex printing mode by providing the blocking members 50 and 60.

Here, the blocking members 50 and 60 block the air flows air1 and air2 in a position closer to the inlet (lower side of the contact region 201) of the sheet to the contact region 201 than the outlet port (upper side of the contact region 201) of the sheet from the contact region 201. This is because if the air flows air1 and air2 are blocked in a position closer to the outlet port (upper side of the contact region 201) of the sheet from the contact region 201, the blocked air flows flow back, the air flows to come into contact with a portion of the sheet which passes through the upper side of the contact region 201, the portion is wetted, and thereby there is a concern that it leads to image defects. In the case of the exemplary embodiment, the blocking members 50 and 60 block the air flows air1 and air2 in the position closer to the inlet (lower side of the contact region 201) of the sheet to the contact region 201. Therefore, the blocked air hardly flows on the inlet side and also on the outlet port side of the contact region 201, and it is possible to reliably suppress disturbance of the image described above.

In addition, the blocking members 50 and 60 are disposed in a non-contact manner with the pressure roll 210 and the heating roll 220. One reason is that if the blocking members 50 and 60 are in contact with the pressure roll 210 and the heating roll 220, there is a concern that mechanical failure occurs, for example, smooth rotations of the pressure roll 210 and the heating roll 220 are interfered, the pressure roll 210 and the heating roll 220 are damaged, or the blocking members 50 and 60 are deformed depending on materials of the blocking members 50 and 60. In addition, another reason is that if the blocking members 50 and 60 are in contact with the pressure roll 210 and the heating roll 220, there is a concern that the air flows air1 and air2 abut against the blocking members 50 and 60 and thereby liquefied moisture transmitted to the pressure roll 210 and the heating roll 220 and the liquefied moisture is attached to the sheet, the sheet contains water in a spot shape or a streak shape, and thereby disturbance of the image occurs.

Moreover, in the exemplary embodiment, the blocking members 50 and 60 are configured to be separated bodies from the guide member 30 and the support member 41, and are supported thereon, but it is not necessary to be separated, and the guide member 30 and the support member 41 themselves may be members having structures of the blocking members 50 and 60.

Moreover, in the exemplary embodiment, two blocking members 50 and 60 including the blocking member 50 that blocks the air flow air1 along the pressure roll 210 and the blocking member 60 that blocks the air flow air2 along the heating roll 220 are provided. However, there is no need to necessarily block both the air flows air1 and air2. Even if any one of blocking members is provided, it is possible to suppress water contained in the sheet to the degree of suppressing the disturbance of the image by the configuration of the image forming apparatus 100 or the fixing machine 200.

Furthermore, in the exemplary embodiment, the configuration including both roll-shaped fixing members that are the pressure roll 210 and the heating roll 220 is described as an example, but it is possible to apply the exemplary embodiment of the invention even in a case of a fixing machine or an image forming apparatus including one or both fixing members which is a circulation belt-type.

### EXAMPLE

We conducted an experiment and confirmed a blocking effect in which the blocking member blocked the air flow generated due to the rotation of the pressure roll and the heating roll under the following conditions:

Image forming apparatus: DocuCentre-IV 4070 of Fuji Xerox:

Processing speed: 242 mm/s: and

Distance between each blocking member and each fixing member: 2 mm or less.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A fixing device for an image forming apparatus, the fixing device comprising:
a pair of fixing members that contacts each other at a contact region, rotates in a direction opposite to each other or circularly moves in a direction opposite to each other, transports a sheet which holds a toner image, and fixes the toner image on the sheet by heating and pressing the sheet during passing through the contact region; and
a blocking member that blocks an air flow along at least one of the pair of the fixing member, the air flow flowing from a sheet outlet port side of the contact region to a sheet inlet side of the contact region, and the air flow being generated due to the rotation or the circular movement of the pair of the fixing members,
wherein an angle between a surface plane of the blocking member on an upstream side of the air flow and a tangential plane of the fixing member at an intersection of the surface plane and a surface of the fixing member is an obtuse angle, the tangential plane being a half plane divided by the intersection and extending from the intersection toward the upstream side of the air flow.

2. The fixing device according to claim 1,
wherein a pair of the blocking members that respectively block air flows flowing along the pair of the fixing members are provided.

3. The fixing device according to claim 1,
wherein the blocking member is not in contact with the fixing member.

4. The fixing device according to claim 1,
wherein the blocking member is disposed at a position closer to the sheet inlet side of the contact region than the sheet outlet port side of the contact region.

5. An image forming apparatus including a fixing device that performs fixing a toner image on a sheet, the image forming apparatus comprising:
an image forming portion that forms the toner image on the sheet that is transported;
a sheet transporting portion that transports the sheet so as to follow a sheet transporting path in which the sheet passes through the image forming portion and the fixing device, and passes through the image forming portion and the fixing device again by being reversed; and
the fixing device comprising:
a pair of fixing members that contacts each other at a contact region, rotates in a direction opposite to each other or circularly moves in a direction opposite to each other, transports the sheet which holds the toner image, and fixes the toner image on the sheet by heating and pressing the sheet during passing through the contact region; and
a blocking member that blocks an air flow along at least one of the pair of the fixing member, the air flow flowing from a sheet outlet port side of the contact region to a sheet inlet side of the contact region, and the air flow being generated due to the rotation or the circular movement of the pair of the fixing members,
wherein an angle between a surface plane of the blocking member on an upstream side of the air flow and a tangential plane of the fixing member at an intersection of the surface plane and a surface of the fixing member is an obtuse angle, the tangential plane being a half plane divided by the intersection and extending from the intersection toward the upstream side of the air flow.

6. A fixing device for an image forming apparatus, the fixing device comprising:
a pair of fixing members that contacts each other at a contact region, transports a sheet which holds a toner image and fixes the toner image on the sheet by heat;
a guide member that guides the sheet toward the contact region;
a support member that supports a guide member; and
a blocking member that extends from at least one of the support member and the guide member toward one of the fixing members, the blocking member blocking an air flow generated due to the rotation or the circular movement of the pair of the fixing members,
wherein an angle between a surface plane of the blocking member on an upstream side of the air flow and a tangential plane of at least one of the fixing members at an intersection of the surface plane and a surface of the at least one of the fixing members is an obtuse angle, the tangential plane being a half plane divided by the intersection and extending from the intersection toward the upstream side of the air flow.

7. (canceled)

8. The fixing device according to claim 6,
wherein the blocking member is disposed at a position closer to a sheet inlet side of the contact region than a sheet outlet side of the contact region.

9. The fixing device according to claim 6,
wherein the tip of the blocking member is not in contact with the fixing member.

10. The fixing device according to claim 6,
wherein at least one of the fixing members is a roll-type.

11. The fixing device according to claim 6,
wherein at least one of the fixing members is a circulation belt-type.
